(19) United States
(12) Patent Application Publication
(10) Pub. No.: US 2020/0264133 A1
(43) Pub. Date: Aug. 20, 2020

(54) METHODS AND DEVICES FOR THE SEPARATION, DETECTION AND MEASUREMENT OF MOLECULES IN LIQUID SAMPLES

(71) Applicant: Groupe E.N. Biomédical Inc., Québec (CA)

(72) Inventor: Elena HAIDET, Québec (CA)

(21) Appl. No.: 16/500,579

(22) PCT Filed: Mar. 29, 2018
(86) PCT No.: PCT/IB2018/052195

§ 371 Date: Oct. 3, 2019

Related U.S. Application Data
(60) Provisional application No. 62/480,683, filed on Apr. 3, 2017.

(51) Int. Cl. G01N 27/453; G01N 1/34; G01N 1/40; B01L 3/00; B01D 71/50

(52) U.S. Cl. CPC G01N 27/453; G01N 1/34; G01N 1/4005; G01N 2001/4038; B01D 71/50; G01N 2001/4016; B01L 3/502715

(57) ABSTRACT

The invention relates to the field of microfluidic detection and analyses. Described herein are methods and devices for the separation, detection and measurement of molecules in liquid samples. Certain aspects of the invention concerns the separation of analyte(s) of interest based on the combined use of: (i) membrane separation, (ii) an electric field and/or a magnetic field; and (iii) capillary action and/or gravity. Envisioned applications include separation, detection and/or measurement of analytes in blood samples, food samples and environmental samples. One particular example is a portable biosensor for the detection and measurement of histamine and diamine oxidase (DOA) in a drop of blood.

### FIELD OF THE INVENTION

The invention relates to the field of microfluidic detection and analyses. More particularly invention relates to the separation, detection and/or measurement of analytes in liquid samples, such as a biomedical device for the detection and measurement of desired analyte(s) such as histamine and diamine oxidase (DOA), in biological fluids.

### BACKGROUND OF THE INVENTION

In the biomedical field, as well as many other fields, there are many advantages associated with portable devices capable to detect and quantify small quantities of an analyte of interest on the spot. For instance, point-of-care testing (POCT) allows medical professionals to reach a diagnostic quickly and treat their patients at the place of patient care without having to sending off specimens away to a laboratory and then waiting hours or days to learn the results. In other industries such food industries, POCT enables food processors and regulatory authorities to measure the absence or presence of potentially harmful pathogenic organisms before the food is sent on the market.

Many existing quantitative methods for biological liquids analyses are slow and cumbersome. There are rapid qualitative or semi-quantitative methods that exist but only few apply to organic liquids. One of the main issue with developing fast or ambulatory measurement methods and devices is associated with the separation or purification of the analyte(s) or constituent(s) to be quantified or detected. Indeed, biological fluids such as blood, urine and saliva comprise cells as well as many other types of molecules that are likely to interfere with the detection and quantification of the analyte of interest.

For instance, histamine is present in almost all tissues, mainly stored in the metachromatic granules of mast cells and basophil leukocytes. Histamine is one of the most important chemical mediators in humans and animals and it is found mainly in the initial phase of an anaphylactic reaction (allergy of “immediate” type). Currently histamine detection has a huge drawback. Because it possesses a very short (15 minutes in vivo) half-life, it is impossible to detect histamine in emergency situations. Therefore a rapid medical response is very much more limited in the event of an anaphylactic shock, the most dangerous complication in allergies. The only quick intervention that can be done is to preventively inject ephedrine to a subject susceptible to suffer from such anaphylactic shock without verifying beforehand whether the subject actually has an allergy or not because there is currently no direct, fast or ambulatory method for the detection of histamine.

Biosensors for histamine determination such as those described in International PCT publications WO 2008/115044 and WO 01/02827 are known, but those biosensors are limited to detection in food or beverages and they require extraction of the histamine first.

Accordingly, there is a need for methods, devices and kits for the separation, detection and measurement of desired analyte(s) in liquid samples.

There is particularly a need for methods, devices and kits for the detection and measurement of histamine and diamine oxidase (DOA) in biological fluids.

There is a need also for a miniaturized and portable instrument for quantitative measurement of analyte(s) in various liquid-based samples such as water, beverages, food samples, chemical samples, and the like.

There is further a need for a biosensor capable of microfluidic separation and capable of detection of desired analyte(s) in body fluids such as blood, saliva, urine, amniotic liquid and tissues.

The present invention addresses these needs and other needs as it will be apparent from review of the disclosure and description of the features of the invention hereinafter.

### BRIEF SUMMARY OF THE INVENTION

The invention relates to methods, devices, strips and kits for the separation of analyte(s) in a liquid sample.

According to one aspect, the invention relates to a method for the separation of analyte(s) in a liquid sample, comprising:
providing a liquid sample comprising at least one analyte to be separated and other constituents, wherein said at least one analyte to be separated has a greater size and a charge different from other constituents in the liquid sample;
depositing said liquid sample onto a first zone of a microporous membrane, said membrane comprising pores having a size allowing passage of at least certain of said other constituents but not passage of the least one analyte to be separated;
creating an electric field at least one of above and below said microporous membrane, wherein
   if positioned below said microporous membrane, said electric field induces electric charges of a similar charge than said at least one analyte to be separated and of an opposed charge to said other constituents;
   if positioned above said microporous membrane, said electric field induces electric charges of an opposed charge than said at least one analyte to be separated and of a similar charge to said other constituents;
   allowing said liquid sample to flow along said membrane to a second distanced zone;

wherein said at least one analyte flow toward said second distanced zone while being prevented from passing through said membrane, said at least one analyte being either repulsed or attracted by the at least one said electric field depending of the electric field charge and position; and

wherein constituents having a size smaller than the size of the pores of the membrane pass through said membrane while flowing away from the first zone, said constituents being either repulsed or attracted by the at least one said electric field depending of the electric field charge and position.

According to another aspect, the invention relates to a method for the separation of analyte(s) in a liquid sample, comprising:
providing a liquid sample comprising at least one analyte to be separated and other constituents, wherein said at least one analyte to be separated has a greater size and a charge different from other constituents in the liquid sample;
depositing said liquid sample onto a first zone of a microporous membrane, said membrane comprising pores having a size allowing passage of at least certain of said other constituents but not passage of the least one analyte to be separated;
applying an electric current above and below said microporous membrane, wherein
   said electric current induces below said microporous membrane electric charges of a similar charge than said at least one analyte to be separated and of an opposed charge to certain of said other constituents;
   said electric current induces above said microporous membrane electric charges of an opposed charge than said at least one analyte to be separated and of a similar charge to certain of said other constituents;
allowing said liquid sample to flow along said membrane to a second distanced zone;
   wherein said at least one analyte flow toward said second distanced zone while being prevented from passing through said membrane, said at least one analyte being at least one of repulsed by said electric charges below the membrane and attracted by said electric charges above said membrane; and
   wherein constituents having a size smaller than the size of the pores of the membrane pass through said membrane while flowing away from the first zone, said constituents being at least one of repulsed by said electric charges above the membrane and attracted by said electric charges below said membrane.

According to another aspect, the invention relates to a device for the separation of at least one of analyte present in a liquid sample, comprising:
a microporous membrane comprising pores with a size allowing passage of at least certain constituents present in said liquid sample but not passage of at least one analyte to be separated;
a first electrode extending above said membrane and positioned to be in fluid communication with an upper surface of the microporous membrane; and
a second electrode extending below said membrane and positioned to be in fluid communication with a lower surface of the microporous membrane;
   each of said electrode comprising a connector adapted to be connected to an electrical source.

According to another aspect, the invention relates to a strip for the separation of analyte(s) present in a liquid sample, comprising:
an elongated membrane, said membrane comprising:
   (i) a separation zone for depositing a liquid sample comprising at least one analyte to be detected and other constituents, wherein said at least one analyte to be detected has a greater size and a charge different from other constituents that are present in the liquid sample;
   (ii) a reaction zone for receiving and reacting said at least one analyte; and
   (iii) a neutral zone in between the separation zone and the reaction zone, the neutral zone allowing flow of said at least one analyte from the separation zone to the reaction zone;
      wherein the separation zone comprises an elongated microporous membrane, said membrane comprising pores with a size allowing passage of certain of said certain constituents but not passage said at least one analyte;
      wherein the neutral zone comprises a surface allowing flow of said at least one analyte by at least one of capillary action and gravity;
      wherein the reaction zone comprises a mixture of compounds allowing an electrochemical reaction with said at least one analyte reaching the reaction zone, and wherein said electrochemical reaction generates a measurable current;
a plurality of electrodes operatively connected to the reaction zone for carrying an electric signal.

According to another aspect, the invention relates to a method for the separation of white blood cells from red blood cells in a biological sample, comprising:
depositing a liquid biological sample comprising white blood cells and red blood cells onto a first zone of a microporous membrane, said membrane comprising pores having a size allowing passage of red blood cells but not passage of white blood cells, said first zone being positioned at one end of said membrane;
applying at least one of a positive electric current below the microporous membrane and a negative electric current above the microporous membrane; and;
allowing said biological sample to flow along said membrane to a second distanced zone;

wherein said white blood cells flow toward said second distanced zone while being prevented from passing through said membrane and being at least one of repulsed by the positive current below the membrane and attracted by the negative current above said membrane; and

wherein said red blood cells flow toward said second distanced zone while being allowed to pass through said membrane and being at least one of repulsed by the negative current above the membrane and attracted by the positive current below said membrane.

According to another aspect, the invention relates to a method for the separation of white blood cells from red blood cells in a biological sample, comprising:
depositing a liquid biological sample comprising white blood cells and red blood cells onto a first zone of a microporous membrane, said membrane comprising pores having a size allowing passage of red blood cells but not passage of white blood cells, said first zone being positioned at one end of said membrane;
applying a positive electric current below the microporous membrane and a negative electric current above the microporous membrane;
allowing white blood cells and red blood cells to flow along said membrane to a second distanced zone;

wherein said white blood cells flow toward said second distanced zone while being prevented from passing through said membrane and being at least one of repulsed by the positive current below the membrane and attracted by the negative current above said membrane; and

wherein said red blood cells flow toward said second distanced zone while being allowed to pass through said membrane and being at least one of repulsed by the negative current above the membrane and attracted by the positive current below said membrane.

According to another aspect, the invention relates to a device for the separation of white blood cells from red blood cells in a biological sample, comprising:
a microporous membrane, said membrane comprising pores with a size allowing passage of red blood cells but not passage of white blood cells, the membrane allowing flow of said red blood cells and white blood cells by at least one of capillary action and gravity;
a first electrode extending above said membrane and positioned to be in fluid communication with an upper surface of the microporous membrane; and
a second electrode extending below said membrane positioned to be in fluid communication with a lower surface of the microporous membrane;
   wherein each of said electrodes comprises a connector adapted to be connected to an electrical source.

According to another aspect, the invention relates to a device for the detection of an analyte(s) in a liquid sample, comprising:
a separation zone for depositing a liquid sample comprising at least one analyte to be detected and other constituents, wherein said at least one analyte has a greater size and a charge different from other constituents in the liquid sample;
a reaction zone for receiving and reacting said at least one analyte;
a neutral zone in between the separation zone and the reaction zone, the neutral zone allowing flow said at least one analyte from the separation zone to the reaction zone;
wherein said at least one analyte is detected at the reaction zone by at least one of amperometry, potentiometry, colorimetry and photometry.

According to another aspect, the invention relates to a method for the detection of analyte(s) that are present in a liquid sample, comprising:
providing a liquid sample comprising at least one analyte to be detected and other constituents, wherein said at least one analyte to be detected has a greater size and a charge different from other constituents that are present in the liquid sample;
depositing said liquid sample onto a first zone of a microporous membrane, said membrane comprising pores having a size allowing passage certain of said constituents but not passage of said at least one analyte;
applying an electric current above and below said microporous membrane, wherein
   said electric current induces below said microporous membrane electric charges of a similar charge than said at least one analyte to be separated and of an opposed charge to certain of said other constituents;
   said electric current induces above said microporous membrane electric charges of an opposed charge than said at least one analyte to be separated and of a similar charge to certain of said other constituents;
allowing said at least one analyte to flow along said membrane to a first distanced zone of the microporous membrane,
   wherein said at least one analyte flow toward said first distanced zone while being prevented from passing through said membrane, said at least one analyte being at least one of repulsed by said electric charges below the membrane and attracted by said electric charges above said membrane; and
   wherein constituents having a size smaller than the size of the pores of the membrane pass through said membrane while flowing away from the first zone, said constituents being at least one of repulsed by said electric charges above the membrane and attracted by said electric charges below said membrane;
turning off said electric current when at least one of fluid and said at least one analyte is detected at said first distanced zone;
allowing said at least one analyte to flow from said first distanced zone to a further distanced second zone;

According to another aspect, the invention relates to a method for the detection of at least one analyte composing white blood cells present in a blood sample, comprising:
depositing a blood sample comprising white blood cells and red blood cells onto a first zone of a microporous membrane, said membrane comprising pores with a size allowing passage of red blood cells but not passage of white blood cells;
applying a positive electric current below the microporous membrane and a negative electric current above the microporous membrane;
allowing white blood cells and red blood cells to flow along said membrane to a second distanced zone;
   wherein white blood cells flow along said membrane toward said second distanced zone and being at least one of repulsed by the positive current below the membrane and attracted by the negative current above said membrane; and
   wherein said red blood cells flow toward said second distanced zone while being allowed to pass through said membrane and being at least one of repulsed by the negative current above the membrane and attracted by the positive current below said membrane;
turning off said positive and negative electric current when at least one of fluid, white blood cells and red blood cells are detected at said first distanced zone;
allowing white blood cells to flow from said first distanced zone to a further second distanced zone;
detecting said at least one analyte composing white blood cells at said second distanced zone.

According to another aspect, the invention relates to a strip for the separation of analyte(s) present in a liquid sample, comprising:
an elongated membrane, said membrane comprising:
   (i) a separation zone for depositing a liquid sample comprising at least one analyte to be detected and other constituents, wherein said at least one analyte to be detected has a greater size and a charge different from other constituents that are present in the liquid sample;
   (ii) a reaction zone for receiving and reacting said at least one analyte; and
   (iii) a neutral zone in between the separation zone and the reaction zone, the neutral zone allowing flow of said at least one analyte from the separation zone to the reaction zone;
      wherein the separation zone comprises:
         an elongated microporous membrane, said membrane comprising pores with a size allowing passage of certain of said certain constituents but not passage said at least one analyte;
         a first electrode extending above said membrane and positioned to be in fluid communication with an upper surface of the microporous membrane;
         a second electrode extending below said membrane and positioned to be in fluid communication with a lower surface of the microporous membrane;
         wherein each of said electrode comprise a connector adapted to be connected to an electrical source;
      wherein the neutral zone comprises:
         a surface allowing flow of said at least one analyte by at least one of capillary action and gravity;
         a sensor positioned and adapted for detecting at least one of fluid, said at least one analyte and said other constituents reaching the neutral zone;
      wherein the reaction zone comprises:
         a mixture of compounds allowing an electrochemical reaction with said at least one analyte reaching the reaction zone, said electrochemical reaction generates a measurable current;
         a plurality of electrodes in electric communication with the mixture of compounds for carrying an electric signal to a reader;

According to another aspect, the invention relates to a portable biosensor, comprising:
a slot to insert a thin elongated strip comprising (i) a separation zone; (ii) a reaction zone; and (iii) a neutral zone in between the separation zone and the reaction zone;
an elongated enclosure to receive said elongated strip;
an electrical source adapted to be connected and to be in electric communication with the separation zone of elongated strip, the electrical source providing an electric current to the separation zone;
an interrupter adapted to be connected and to be in electric communication with the neutral zone of the elongated strip and with the electrical source, the interrupter turning off the electric current to the separation zone when receiving predetermined electric signal from the neutral zone;
a reader adapted to be connected and to be in electric communication with the reaction zone of the elongated strip, the reader providing to the reaction zone and receiving therefrom electric signals.

According to another aspect, the invention relates to a method for the separation of analyte(s) present in a liquid sample, comprising:
providing a liquid sample comprising at least one analyte to be separated and other constituents, wherein said at least one analyte to be separated has a greater size and a charge different from other constituents in the liquid sample;
isolating said at least one analyte through the combined action of: (i) microporous membrane separation; (ii) at least one of electric field and magnetic field; and (iii) at least one of capillary action and gravity.

According to another aspect, the invention relates to a kit comprising a device and/or a biosensor as defined herein, and at least one strip as defined herein.

### BRIEF DESCRIPTION OF THE DRAWINGS

In order that the invention may be readily understood, embodiments of the invention are illustrated by way of example in the accompanying drawings.

FIG. 1 is a schematic top view of a detection device according to one embodiment of the invention, the device having the shape of an elongated strip comprising a separation zone, a neutral zone and a reaction zone,

FIG. 2 is a schematic cross-section view of the detection device if FIG. 1.

FIG. 3 is a schematic cross-section of a separation zone taken along the lines shown in FIG. 2.

FIG. 4 is a schematic cross-section of a neutral zone taken along the lines shown in

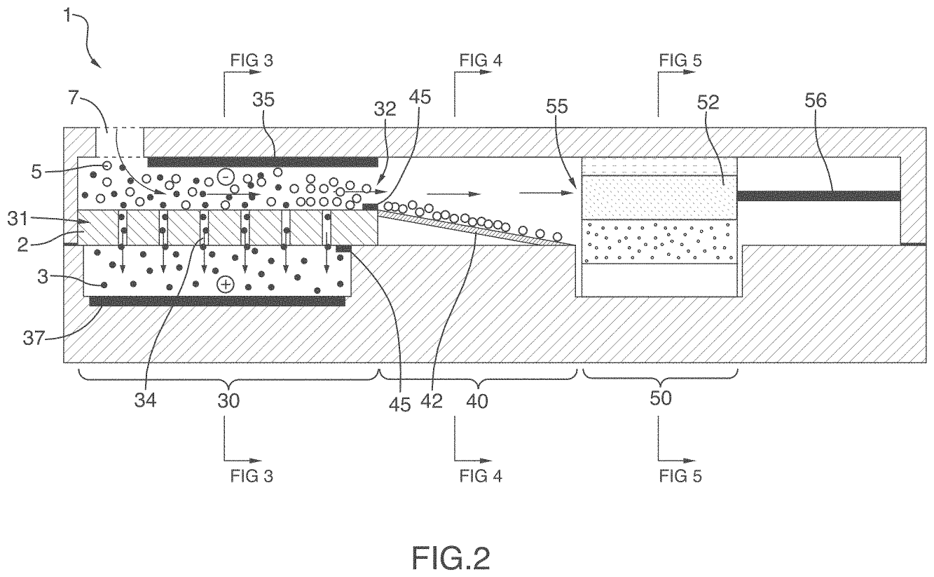

FIG. 2.

FIG. 5 is a schematic cross-section of a reaction zone taken along the lines shown in

FIG. 2.

FIG. 6 is a schematic cross-section of a separation zone comprising magnets, according to another embodiment of the invention.

FIG. 7 is a diagram of an electric circuit electric of a biosensor, according to one embodiment of the invention.

FIG. 8 is a top perspective view of a biosensor according to one embodiment of the invention.

Further details of the invention and its advantages will be apparent from the detailed description included below.

### DETAILED DESCRIPTION OF PREFERRED EMBODIMENTS

In the following description of the embodiments, references to the accompanying drawings are by way of illustration of an example by which the invention may be practiced. It will be understood that other embodiments may be made without departing from the scope of the invention disclosed.

A) Separation of Desired Analyte(s) that are Present in a Liquid Sample

One of the main issues associated with point-of-care testing (POCT) is the separation and/or purification of analyte(s) to be detected and/or quantified.

According to one aspect, the invention relates to the separation of analyte(s) of interest in a liquid sample. As used herein, the term “analyte” refers to any chemical species that is present in a liquid sample and that is sought to be detected, quantified, and/or sought to be separated from other constituent(s) in the liquid sample. The term “analyte” includes, without limitation, natural and chemically synthesized molecules, cells, nucleic acids, proteins, lipids, etc. The analyte may be free in solution, it may be coupled or conjugated to another molecule and/or it may be a part of a larger and/or more complex component (e.g. the analyte is a biological molecule inside a living cell).

According to this particular aspect of the invention, the separation of the analyte(s) of interest is based on the combined use of: (i) membrane separation, (ii) at least one of electric field and magnetic field; and (iii) at least one of capillary action and gravity. Indeed, various constituents in a sample are known to have different sizes and different electric charges, and according to the present invention, the combined used of (i), (ii) and (iii) as defined above allows to isolate, to purify and/or to concentrate selected analytes based on the respective size and electric charge of these analytes.

One particular example concerns white blood cells and red blood cells in a blood sample. Normal red blood cells (RBCs) (also known as erythrocytes) have a diameter of about 6 to 8 μm, whereas white blood cells (WBCs) (also known as neutrophils or leucocytes) are 12 to 15 μm in diameter. Also, RBCs have a negative charge whereas WBCs have a positive charge.

Accordingly, the present inventor has considered these fundamental differences in diameter and electric charges of these cells to develop a method for the separation of white blood cells from red blood cells in a biological sample.

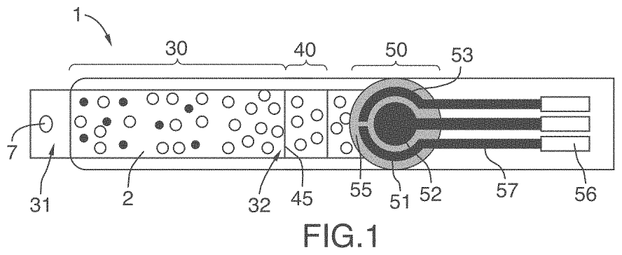

In one embodiment illustrated at FIGS. 1 and 2, the method comprises the following steps. First, a device 1 comprising a separation zone 30 is provided. The separation zone 30 comprises a microporous membrane 2. A liquid biological sample comprising red blood cells (RBCs) 3 and white blood cells (WBCs) 5 and is deposited onto the microporous membrane 2. The sample is preferably deposited onto a designated spot 7 of a first zone 31 positioned at one end of the membrane 2 and the sample is allowed to flow from by capillary action and/or gravity from the first zone 31 to a second distanced zone 32. The membrane 2 comprises pores 64 having a size allowing passage of RBCs 3 but not the passage of WBCs 5 (e.g. pores having a diameter of about 10 μm). Although preferable, it is to be understood that reference to “a size allowing passage of . . . but not the passage of . . . ” do not necessarily mean an absolute barrier and that a certain amount cells may succeed to pass (or not pass) through the membrane, without affecting successful functioning of the present invention.

Second, a positive electric current is applied below the microporous membrane and a negative electric current is also applied above the microporous membrane. As the sample flow on the membrane 2 from the first zone 31 to the second zone 32, the RBCs 3 are attracted by the positive current under the membrane 2 (and/or repulsed from the negative electric current above the microporous membrane) and they are allowed to pass through the membrane 2 via the pores 34 because of their smaller size. To the contrary, during the flow of the sample, the WBCs 5 are prevented from passing through the pores 34 of the membrane 2 because of their larger size and because they are repulsed from the positive electric current under the membrane 2 (and/or they are attracted to the negative electric current above the microporous membrane).

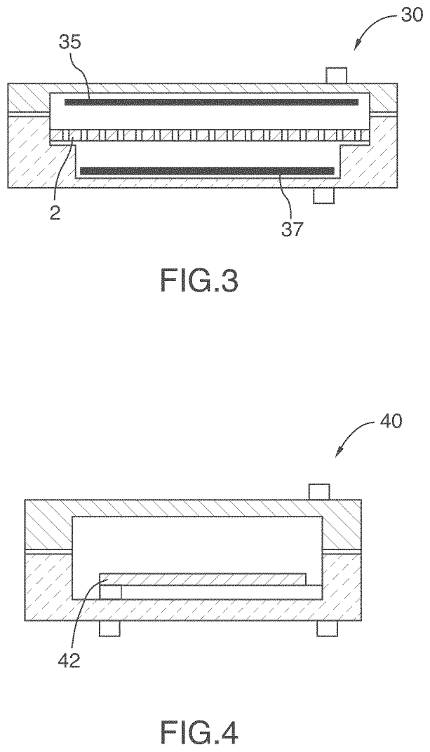

In one embodiment the current is provided to the membrane by means of electrodes 35, 37 extending above and below the membrane as illustrated in FIGS. 1, 2 and 3. A first electrode 35 extends above the membrane 2 and this electrode is positioned to be in fluid communication with an upper surface of the microporous membrane 2 when the sample is deposited onto and flows above the membrane. A second electrode 37 extends below the membrane and it is positioned to be in fluid communication with a lower surface of the microporous membrane 2 when the sample is deposited onto, traverses and flows below the membrane.

Nevertheless, it may be envisioned to provide only one electrode positioned either above or below the membrane to induce electric charges above or below the microporous membrane, respectively. For instance, providing only a negative electric current above the microporous membrane may provide the same desired results, i.e. repulsing RBCs 3 such that they pass through the membrane 2 while attracting the WBCs 5 so they stay above the membrane 2. Nevertheless, providing opposed electric current above and below the membrane is preferred since the presence of two electrodes will likely accelerate the separation process and/or improve efficacy of the separation.

As can be appreciated and as shown in FIGS. 1 and 2, the combination of directional flow, electric field and membrane separation results in gradual elimination of RBCs 3 from the surface of the membrane and in gradual concentration of WBCs 5 from the first zone 31 to the second distanced zone 32. Accordingly, parameters such as the flow (including the width and length of the channel if any), the electric current, membrane width, length, and/or properties can be adjusted such that when the liquid sample reaches the second zone 32 the sample is enriched in WBCs 5 with no or few RBCs 3.

In one embodiment, the current in the electrodes is continuous direct current (DC). Nevertheless in may be envisioned to use alternating current (AC), pulse current and combinations thereof. In embodiments, the current to the electrode(s) is about 0.01 mV to 0.1 mV.

Alternatively, instead of applying an electric current above and/or below the microporous membrane, it may be envisioned achieve the same results by ways of a magnetic field as illustrated in FIG. 6. Indeed, by a magnetic field may be created above and/or below the microporous membrane 2 by using magnets 39N, 39S located on each side of the membrane 2 with opposed polarization for inducing desired electric charges having either an attractive and/or repulsive effect on the analyte(s) and/or other constituents flowing on and through the membrane 2.

The membrane 2 is selected to provide an acceptable flow by capillary action, while providing pores of a determined size. For instance, to allow the passage of RBCs 3 and not WBCs 5, the membrane 2 preferably comprises pores 34 having a diameter of less about 10 μm. In one embodiment, membrane 2 is a polycarbonate membrane (e.g. TCTP 02500, Millipore™ Sigma). The membrane may also be made of other another suitable material such as polyamide, cellulose acetate, or from ceramic material. In may also be envisioned to alter the membrane's binding properties to make it more or less attractive to certain analytes or constituents (e.g. having a membrane comprising positive or negative charges, membrane with conjugated antibodies having an affinity to certain molecules, etc. Those skilled in the art will appreciate that the physical and chemical properties of the membrane (e.g. pores diameter, type of membrane, composition of the membrane, presence of a coating or conjugated species, presence of electric charges, etc.) may be selected according to various factors such as the desired uses, the desired sensitivity, the nature, origin and/or density of the fluid sample, the identity and/or concentration of the constituent(s) and/or analyte(s), etc.

As indicated, the liquid sample may flow along the membrane 2 by capillary action and/or gravity. To facilitate a flow by gravity, the membrane is preferably angled toward the ground (e.g. by about 10 to about 30 degree). The membrane may also comprise a canal in which the sample can flow. A liquid (e.g. aqueous solution, solvent, buffer) may be deposited before and/or after deposition of the sample to assist in the flow of the liquid sample.

Biological samples for use in the methods include, but are not limited to, blood, plasma, saliva, urine, amniotic liquid, vaginal secretions, and the like. The method may also be applied to the separation and/or purification of WBCs and RBCs from other types fluid such as buffer, laboratory samples, etc.

The present separation method is not restricted to separation of WBCs and RBCs. As can be appreciated, the principles of the present method can be applied to the separation and/or purification of many different types of analytes obtained from many different types of fluids or liquids. For instance it may be envisioned to adapt the membrane and electric current for separation and/or purification of: various types of cells (e.g. cells from different tissues, cells from different species (mammalian, plant, microorganisms, plant, etc.), natural and/or synthetic nucleic acids (e.g. DNA, RNA), proteins, antibodies, lipids, chemicals (e.g. small molecules, polymers, etc.), and the like. The principles of the invention may also be applied to separation of conjugated molecules including but not limited to proteins, cells and the like that have been captured by antibodies that are conjugated to magnetic or metal beads (and thus responsive to the electric current), etc. The analyte(s) may originate from biological fluids as well any other liquid for which separation of selected components is desired including, but not limited to, water samples, beverages (e.g. beer, wine, champagne, juice, etc.), food samples, chemical samples, and the like.

### B) Detection and Quantification of Analyte(s) Present in a Liquid Sample

According to another mains aspect, the invention relates to methods, devices and strips for the quantitative measurement of analyte(s) in a liquid sample. In this context, the term “analyte” having the same definition as the one provided hereinbefore.

As indicated hereinbefore, the separation/purification method and devices according to the present invention results in sample enriched in a desired analyte (e.g. WBCs) with no or few undesirable constituents (e.g. RBCs). Accordingly, another aspect of the present invention takes advantage of that previous enrichment/purification for the detection and quantitative measurement of desired analyte(s) in the liquid sample.

Therefore, according to one embodiment of a detection method according to the invention, the following steps are applied once the liquid sample reaches the second zone of the membrane: (i) electric current is turned off when at least one of fluid and constituents are detected at the first distanced zone; (ii) the constituents at the first distanced zone are allowed to flow to a further second distanced zone; and (iii) constituents reaching the second distanced zone are detected and/or quantified.

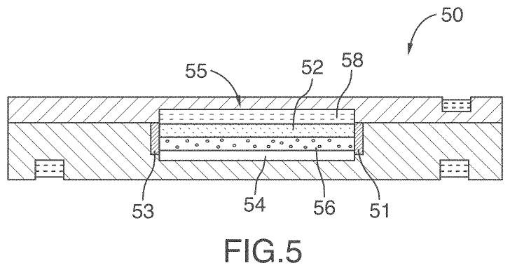

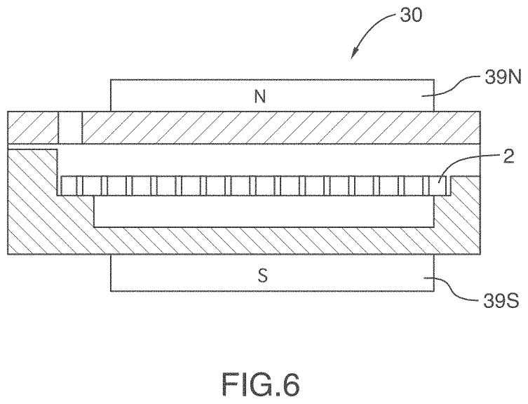

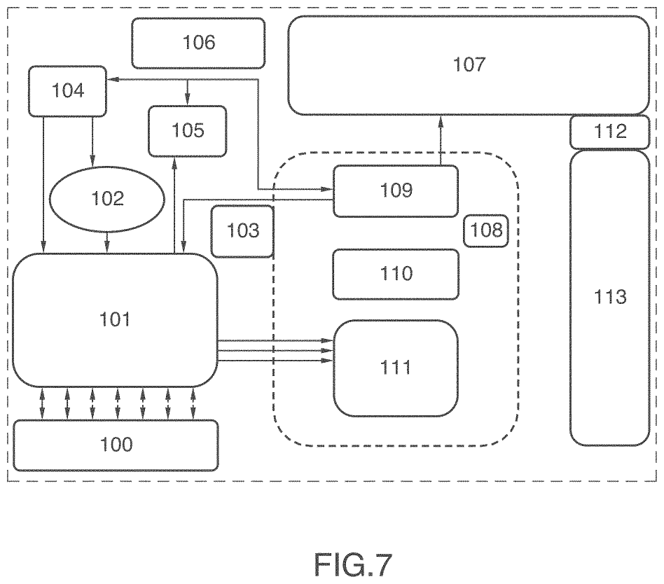

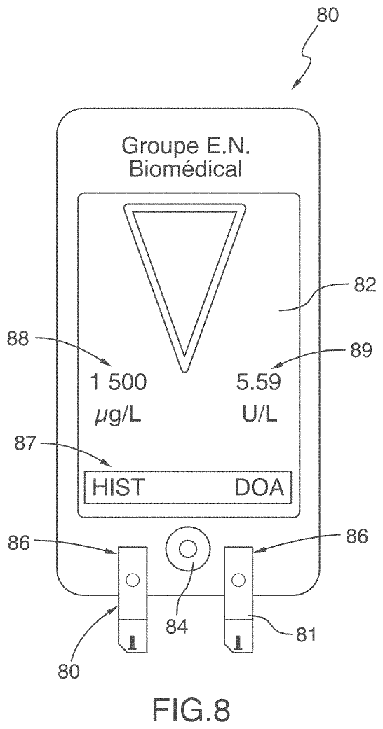

This method can be carried out using a device such as the device of FIGS. 1 to 5. In that embodiment the device 1 comprises: a separation zone 30 for depositing the liquid sample comprising at least one analyte to be detected and other constituents, wherein the at least one analyte to be detected has a greater size and a charge different from other constituents that are present in the liquid sample. The device also comprises a reaction zone 50 for receiving and reacting at least one analyte to be detected. The device further comprises a neutral zone 40 in between the separation zone 30 and the reaction zone 50, the neutral zone 40 allowing the flow of at least one analyte from the separation zone 30 to the reaction zone 50. As explained with more details hereinafter, the at least one analyte is detected at the reaction zone 50 by using any suitable method, including but not limited to amperometry, colorimetry and photometry.

The neutral zone 40 comprises a surface 42 allowing the flow of the desired analyte(s) by at least one of capillary action and gravity (e.g. a downward angle of about 10 to 30 degrees). In the embodiment illustrated in FIGS. 1, 2 and 4, the neutral zone 40 is a prolongation of the porous separation membrane 2. The neutral zone 40 may me made of any suitable materials, including but not limited to polymers and cellulose acetate.

In one embodiment such as the one illustrated in FIGS. 1 and 2, the device 1 comprises a sensor 45 positioned and adapted to detect at least one of: fluid, the at least one analyte of interest and/or other constituents in the liquid sample reaching the neutral zone 40. The sensor 45 is configured to send an electric signal to an interrupter turning off the current of the electrode(s) in the separation zone 30. For instance, the sensor 45 may comprises a pair of conductors positioned above and/or below the membrane 2, respectively, at a location 32 wherein the separation zone 30 and the neutral zone 40 contact each other.

In one embodiment, the reaction zone 50 comprises a mixture of compounds 55 that is composed of compounds causing a colorimetric reaction to occur when the desired analyte(s) reaches the reaction zone. For instance, the mixture 55 may comprise a colorimetric indicator or a dye sensitive to a redox reaction that occurs when the desired analyte(s) enter into contact with the mixture, thereby indicating the presence of the analyte(s) in the liquid sample. That colorimetric reaction may then be detected by the human eye (e.g. a small transparent window above the reaction zone) and/or by using a dedicated optical detector. The colorimetric reaction may be sufficient by itself to confirm the presence of the analyte in the sample or it may be used in combination with other detection methods to increase the reliability of the device. For instance, colorimetric detection may allow detecting false negatives when used in combination with other detection methods, including amperometric detection as described hereinbelow.

Envisioned examples of colorimetric detection include, but are not limited to, (1) detection a reaction of oxidoreduction by using resazurin (C₁₂H₆NNaO₄), a blue dye itself weakly fluorescent until it is irreversibly reduced to the pink colored and highly red fluorescent resorufin; (2) detection a reaction of oxidation by using a chromogenic substrate such as 3,3′,5,5′-Tetramethylbenzidine (TMB), a white compound that turns to a pale blue-green liquid when oxidized; and/or (3) measuring low concentrations of H₂O₂ by employing a color reagent that contains a dye (e.g. xylenol orange) in an acidic solution with sorbitol and ammonium iron sulfate that reacts to produce a purple color proportional to the concentration of H₂O₂ in the sample (see for instance Hydrogen Peroxide Colorimetric Assay, Product Number CS0270 commercialized by Sigma).

In another embodiment, the reaction zone 50 comprises a mixture of compounds 55 that is composed of compounds causing an electrochemical reaction to occur when the desired analyte(s) reach the reaction zone, that electrochemical reaction generating a measurable current. The measurable current may then be measured using any suitable device such as an amperometric detector or potentiometric detector. In preferred embodiments, the potential of the current generated by the electrochemical reaction is proportional to the amount of analyte(s) reaching the reaction zone. Therefore, the device may operatively connected to a biosensor that is calibrated such that measurements of the current and/or current potential allow a precise quantification of the analyte(s) in the sample.

The reaction zone 50 is illustrated in FIGS. 1, 2, and 5. In the illustrated embodiment a plurality of electrodes 51, 52 and 53 are part of the reaction zone 50. The electrodes are embedded in the mixture of compounds 55 and the electrodes can carry electric signals associated with measurement of the measurable current to an a amperometric detector and/or transducer operatively connected to the electrodes. In this particular embodiment there is provided three electrodes, namely a reference electrode 51, a working electrode 52 and an auxiliary electrode 53.

The reference electrode 51, the working electrode 52 and the auxiliary electrode 53 are part of a three electrodes system, a system for which the principles are well known. Briefly, the working the electrode 52 is the electrode on which the reaction of interest is occurring. The working electrode 52 may be cathodic electrode or an anodic electrode, depending on whether the reaction on the electrode is a reduction or an oxidation, respectively. The working electrode 52 can consist of any suitable materials ranging from inert metals such as gold, silver or platinum, to inert carbon such as glassy carbon or pyrolytic carbon, and mercury drop and film electrodes. The working electrode 52 may also be chemically modified for the analysis of certain organic and inorganic samples. The reference electrode 51 is an electrode having a stable and well-known electrode potential. Its only role is to act as reference in measuring and controlling the working electrode's potential and at no point does it pass any current. The auxiliary electrode 53 passes all the current needed to balance the current observed at the working electrode 52. Like the working electrode 52, the auxiliary electrode 53 and the reference electrode 51 can be made of any suitable materials ranging from inert metals such as gold, silver or platinum, to inert carbon such as glassy carbon or pyrolytic carbon, and mercury drop and film electrodes. Therefore, the working electrode 52, the auxiliary electrode 53 and the reference electrode 51 cooperate to carry electric signals that are analyzed by an amperometric detector.

According to the present invention, the electrodes 51, 52, 53 are preferably thin and they comprise a highly conductive material. For instance, the electrodes may be made of a thin film of nanoparticles of fluoren, gold, platinum, silver and combinations thereof. The working electrode 52 and the reference electrode 51 are preferably coated and/or imprinted with the mixture of compounds 55 that is required for the electrochemical reaction to occur, the working electrode preferably covering a large surface of the reaction zone. As shown in the embodiment of FIG. 1 the electrodes 51, 52, 53 are preferably positioned such that there is a gap in between, the gap avoiding passing of current between the three electrodes in absence of an electrochemical reaction. When the desired analyte reach the reaction zone 50 and becomes into contact with the mixture of compounds 55, electric signals deriving from the electrochemical reaction can be carried out by the electrodes 51, 52, 53 and analyzed, for instance by using an amperometric detector operatively connected to the three electrodes. As such, each electrode may comprise a connector 56 and an elongated wire 57 in between the connector 56 and the reaction zone 50.

In embodiments, the separation zone 30 and the neutral zone 40 may be omitted. For instance, the separation zone 30 and the neutral zone 40 may be facultative in analyzing fluid samples that are highly concentrated in the desired analyte(s), samples that are relatively free from impurities, and/or which are devoid of constituents not interfering with the detection of the analyte(s). This may be the case for instance for water samples, urine, etc.

As exemplified hereinafter, the mixture of compounds 55 in the reaction zone 50 is formulated to allow a colorimetric reaction and/or an electrochemical reaction to occur when the analyte(s) to be detected reach the reaction zone. In embodiments, the colorimetric and/or electrochemical reaction(s) comprises an enzymatic reaction wherein an enzyme is comprises in either one of the analyte to be detected or the mixture of compounds. In one particular embodiment the analyte to be detected is histamine and the mixture of compounds comprises at least diamine oxidase (DOA) as the enzyme. In another embodiment, the analyte to be detected is DAO and the mixture of compounds comprises at least one of a biogenic amine, including but not limited to histamine, putrescine, and cadaverine (e.g. dihydrochloride salts or other salts such as putresceine dihydrochloride, cadaverine dihydrochloride, hexamethylene diamine dihydrochloride benzylamine and histamine dihydrochloride and the like).

Table 1 below provides examples of combinations that can be envisioned according to the present invention.

TABLE 1
Envisioned pairs of compounds for detection

| Analyte to be detected | Active component in the mixture of compounds |
|---|---|
| Histamine | Diamine oxidase* (DOA) |
| Diamine oxidase* (DOA) | histamine, putrescine, and/or cadaverine |
| Glucose | Glucose oxidase* (GOx) |
| Uric acid | Uricase* |
| Urea | Urease* |
| Sulfite | Sulfite oxidase* |
| Lactate | Lactate oxidase* |
| D-serine | D-amino acid oxidase* (DAAO) |
| Ac glutamic | Glutamate oxidase* |
| Cholesterol | Cholesterol oxidase* |
| Ethanol | Ethanol oxidase* |

*Enzyme

In embodiments, the mixture of compounds 55 also comprises various compounds having different purposes in allowing and/or improving the colorimetric and/or electrochemical reaction(s). For instance, the mixture of compounds may include compounds for preserving the enzyme (if any). The mixture of compounds may also include reagents for setting off the enzyme and/or improving its activity. For example, the reagent(s) may comprise activator(s), enzymatic substrate(s), catalyzer(s), buffer(s), organic polymers useful in preserving the enzyme and prevent its degradation during the reaction (e.g. collagen, chitosan) a semiconductor to improve conductivity (e.g. nanoparticles of fluoren, nanoparticles of gold, platinum, and/or silver,), antibacterial agents (e.g. Katon™).

### C) Strips and Tubes

Advantageously, the separation zone 30, the neutral zone 40 and the reaction zone 50 described hereinbefore may be integrated into an elongated strip and/or a tube (e.g. capillary tube) which may be used in combination with a biosensor as described hereinafter. For instance, such an elongated strip may resemble the device of FIGS. 1 and 2.

According to one embodiment, the device is a strip which comprises: (i) a separation zone; (ii) a reaction zone; and (iii) a neutral zone in between the separation zone and the reaction zone. The separation zone comprises an elongated microporous membrane having a dedicated zone for depositing the liquid sample. The microporous membrane comprises pores with a size allowing passage of the desired constituents to be detected/measured but not passage of certain other constituents. Although preferable, it is to be understood that reference to “a size allowing passage of . . . but not the passage of . . . ” do not necessarily mean an absolute barrier and that a certain amount constituents may succeed to pass (or not pass) through the membrane, without affecting successful functioning of the present invention. In embodiments, the membrane allow (and/or prevent) passage of at least 50%, or at least 60%, or at least 75%, or at least 85%, at least 90%, or at least 95%, or at least 99% of the constituents. The neutral zone comprises a surface allowing flow of the desired constituents at least one of capillary action and gravity. The neutral zone may me made of any suitable materials, including but not limited to polycarbonate. To assist gravity flow, the neutral zone may have a downward angle, for instance an angle of about 10 to 30 degrees. The reaction zone comprises a mixture of compounds allowing an electrochemical reaction with constituents reaching the reaction zone, and wherein said electrochemical reaction generates a measurable current. The strip further comprises a plurality of electrodes operatively connected to the reaction zone. Preferably the strip comprises a working electrode, an auxiliary electrode and a reference electrode for use in carrying electric signals associated with measurement of the measurable current to an amperometric detector operatively connected to the electrodes, as described hereinbefore. Preferably also, the composition of the mixture of compounds in the reaction zone comprises is such that it will also cause a colorimetric reaction to occur when the desired analyte(s) reaches the reaction zone as detailed hereinbefore.

The present invention also encompasses strips in which the separation zone and the neutral zone may be omitted. As indicated hereinbefore, these two zones may be facultative, depending of the fluid sample and/or analyte to be analyzed. The separation zone, the neutral zone and/or the reaction zone may be assembled as one single element (e.g. monobloc) or they may be modular. In embodiments, the strip is flexible and printable.

Strips according to the present invention may me be commercialized individually, in a package comprising multiple identical strips or in a package comprising different types of strips. The strip may also be commercialized as part of a kit comprising multiple different strips (i.e. detection of different analytes) and/or as part of a kit comprising (i) a detection device as described hereinafter and (ii) one single strip or a plurality of similar or different strips.

### D) Portable Instrument

Advantageously, the detection device according to the invention is configured for operating in combination with a portable instrument, such as a portable biosensor.

In one embodiment, the portable biosensor comprises a slot to insert a detection device as defined herein, for instance a detection device having the shape of a thin elongated strip or tube and comprising a separation zone 30, a reaction zone 50, and a neutral zone 30 in between the separation zone and the reaction zone. The biosensor also comprises an elongated enclosure to receive the elongated strip or tube.

The biosensor further comprises an electrical source (e.g. electrodes 35, 37) adapted to be connected and to be in electric communication with the separation zone of elongated strip, the electrical source providing an electric current to the separation zone. The biosensor further comprises an interrupter adapted to be connected and to be in electric communication with the neutral zone of the elongated strip and with the electrical source, the interrupter turning off the electric current to the separation zone when receiving predetermined electric signal from the neutral zone (e.g. from sensor 45). The biosensor further comprises a reader adapted to be connected and to be in electric communication with the reaction zone of the elongated strip or tube, the reader providing to the reaction zone and receiving therefrom electric signals (e.g. from electrodes 51, 52, 53).

In addition, the portable biosensor further preferably comprises a transducer and a screen that are in electric communication with the electric connectors, the transducer and the screen cooperating for providing a read out of the electrochemical reaction inside the reading zone.

The biosensor may also comprises also at least one of an ammeter and a photometer. As illustrated in the diagram of FIG. 7, the biosensor may also comprises one or more of the following parts:
an adaptor 100 for the electrodes 51, 52, 53, and/or for the sensor 45 and/or for the electrodes 35, 37;
a potentiostat 101, e.g. a potentiostat formed from two or more operational amplifiers to perform electrochemical measurements (e.g. amperometric or potentiometric measurements);
an optical reader 102;
a UV and/or Visible filter 103 (e.g. for the optical reader);
a digital to analog convertor 104 (e.g. to set the potentials of the reference electrode 51 and working electrode 52);
an analog to digital convertor 105 (e.g. to sample data at high resolution);
button(s) 106 to input commands by a user;
a digital I/O 107 (e.g. to acquire and generate digital signals and patterns at multiple logic levels);
an LCD screen 108 to display results to a user;
a microcontroller 109 to operate the device;
a Central Processing Unit (CPU) 110 to run computer programs;
an analog to digital convertor (ADC) 111 (e.g. to transform measured data to readable information);
communication ports 112 (e.g. to connect the biosensor to to other devices such as a telephone, a computer, a USB card, etc.);
a battery 113 to providing energy to the whole biosensor and its components.

The biosensor and its parts can be manufactured and assembled using known processes/techniques. According to a related aspect, the invention relates to an electronic system comprising one or more of the parts listed above and illustrated in the diagram of FIG. 7.

FIG. 8 provides an illustrated example of an embodiment of a biosensor according to the present invention. For instance, the biosensor 80 may be configured and designed to comprise a large touch screen 82, a command button 84 and two slots 86 for introducing two strips 81, each strip 81 comprising all the required components of the detection device described hereinabove and being configured to provide a quantitative read out of a given analyte. In the embodiment of FIG. 8, the strips 81 are for the quantitative detection of histamine and DOA 87. As such, when detection is completed, the screen 82 provides the identity of the two analytes 87 as well as a read out of their respective measured values 88, 89.

Of course, it is possible to envision many additional types of biosensors, having more or less complex designs and features. Preferably, the biosensor 80 of the invention is user-friendly such that it can be operated by both, qualified personnel (e.g. doctor, nurse) as well as by patients.

### E) Diagnostic Methods

One can appreciate that the present invention may provide numerous benefits and find numerous medical applications.

Particularly, the present invention may allow to quickly obtaining a reliable measure of the amounts of an analyte in a biological sample. For instance, by allowing detection of histamine and/or DAO, the present invention may advantageously provide one or more of the following benefits:
reduce, prevent and/or treat an anaphylactic shock;
reduce mortality induced by anaphylactic shock;
determine a false food allergy;
determine existence of allergies and/or serious drug reactions;
diagnose enzymatic failure such as a lack of DAO;
determine the looming premature rupture of the membrane of a pregnant woman, e.g. by measuring DAO in vaginal fluid;
inflammatory phenomena, e.g. by measuring histamine and/or DAO in blood;
determine the presence of pathologies such as celiac disease and/or colorectal cancer by assessing DAO levels in blood;
determine the presence of one or more indicators of a bacterial infection by measuring Histamine in biological fluids.

Accordingly, additional aspects of the invention concern medical-related methods and uses including, but not limited to, methods for measuring histamine in a biological sample, methods for measuring diamine oxidase in a biological sample, methods for detecting an anaphylactic shock, methods for detecting an allergy and/or a false food allergy, methods for detecting lack of diamine oxidase in a subject, methods for determining the looming premature rupture of the membrane of a pregnant woman, methods for detecting inflammation, methods to diagnose celiac disease, methods to diagnose colorectal cancer, and methods do diagnose a bacterial infection in a subject.

### F) Industrial and Environmental Applications

One can appreciate that the present invention may provide numerous benefits in the industries and also find numerous environmental applications.

Particularly, in the food industry, the present invention may allow to quickly obtaining a reliable measure of the amounts of an analyte in a food sample (e.g. histamine in red meat, fish) or a beverage (e.g. beer, wine, champagne, juice, etc.).

Quickly obtaining a reliable measure of the amounts of an analyte in a water sample may also find numerous benefits for public safety (e.g. water sanitization installations, detection of coliforms at a beach) as well as environmental control (detection of pollutants or contaminants).

Accordingly, additional aspects of the invention concern such uses and related methods including, but not limited to, methods to determine a bacterial contamination in food, methods for detecting pollutant(s) in a water sample, methods for detecting pathogens, methods for detecting chemicals, etc.

### EXAMPLES

### Example 1: Detection of Histamine

According to one particular example, the principles of the present invention are applied to the detection of histamine in a biological fluid, using the enzyme DAO for triggering a colorimetric and an electrochemical reaction. For instance, the following chemical reaction illustrates oxidative deamination of histamine using DAO:

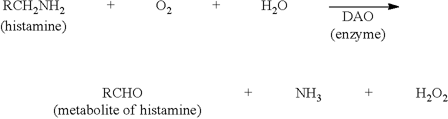

According to this enzymatic reaction, presence of histamine (analyte) in a sample may be detected (quantified) by detecting (measuring) its degradation by way of monitoring O₂ consumed and/or the H₂O₂ (peroxide) produced during the enzymatic reaction.

In one embodiment, the presence of histamine in the sample is correlated to the increase in the cathodic current, for instance a current of −0.10 V, −0.20 V, −0.30 V, −0.40 V, −0.50 V, −0.60 V, −0.70 V, −0.80 V, −0.90 V, −1V, or more. In one embodiment, the presence of histamine in the sample is correlated to a colorimetric reaction resulting from the change of color of a dye reacting with H₂O₂.

According to this particular embodiment, the enzyme DAO is fixed/cross-linked to the working electrode. The DAO is mixed with a polymer (such as chitosan, collagen and fluoren (a semiconductor) in order to improve conductivity. The DAO is also mixed chitosan and collagen to preserve the enzyme and prevent its degradation during the reaction.

The mixture may also comprise a surfactant such as sodium dodecylbenzenesulfonate (SDBS) (e.g. about 0.3-0.5% p/p to prevent agglutination of fluoren and to reduce static electricity from working electrode.

In one particular embodiment, pig kidney diamine oxidase (≥0.05 solid unit/mg; EC 1.4.3.6) was obtained from Sigma-Aldrich to prepare a 2 mg/mL solution in a buffer phosphate (PBS, 100 mM, pH 7.4). The DAO was next immobilized on two membranes (chitosan and collagen) at surface of working electrode.

The DAO was immobilized on the membranes of chitosan-collagen allowing covalent immobilization of DAO. Briefly, 10 μl of a PBS solution containing 80 U/mL DAO was deposited on 1 cm² of chitosan-collagen membrane. The affinity membrane with the DAO was left to dry for 1 hour then it was washed with KCl 1 mol/L.

Preferably, a system of double control (i.e. a colorimetric reaction) is provided in order to eliminate false negatives. For instance, different reagents may be used as a redox indicator according to the present invention. In one embodiment, the mixture comprises resazurine (C₁₂H₆NNaO₄), a weakly fluorescent blue dye that may be reduced to resofurine, a pink dye having a strong fluorescence. Another example is a chromogenic compound such as (3,3′,5,5′-tetramethylbenzidine (TMBZ) that can oxidize and can change color, from white to blue-green. The colorimetric reaction can be measurable, for instance at 400-450 nm.

To manufacture an elongated strip for the detection of histamine, the affinity membrane and the DAO were placed on the working electrode in the following order: (1) the membrane of the cellulose acetate or chitosan collagen or other organic polymer to protect the electrode electrochemical interference, (2) the enzyme membrane and (3) outer polycarbonate to protect the DAO enzyme from harmful molecules and/or from bacteria. The working electrode was polarized at +700 mV vs. Ag/AgCl.

FIG. 5 illustrates an embodiment on how the mixture of compounds 55 may be assembled. In this embodiment, the mixture of compounds 55 comprises multiple layers: (i) a first layer 54 comprising fluoren and SDBS, (ii) a second layer 56 comprising DAO, PBS and CaCl₂, (iii) a third layer 52 comprising nanoparticules, and (iv) a fourth later 58 comprising a protective compound. In embodiments, all these layers are integral to or deposited onto the working electrode.

### Example 2: Detection of Diamine Oxidase (DOA)

According to one particular embodiment, the principles of the present invention are applied to the detection of diamine oxidase (DOA) in a biological fluid, using a biogenic amine for triggering a colorimetric and an electrochemical reaction. For instance, the following chemical reaction illustrates oxidative deamination of histamine (a biogenic amine) using DAO:

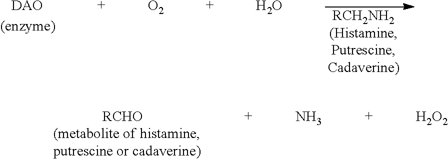

According to this enzymatic reaction, presence of DAO (analyte) in a sample may be detected (quantified) by detecting (measuring) the degradation of at least one of histamine, putrescine, and cadaverine by way of monitoring O₂ consumed and/or the H₂O₂ (peroxide) produced during the enzymatic reaction.

In one embodiment, the presence of DAO in the sample is correlated to the increase in the cathodic current, for instance a current of −0.10 V, −0.20 V, −0.30 V, −0.40 V, −0.50 V, −0.60 V, −0.70 V, −0.80 V, −0.90 V, −1V, or more. In one embodiment, the presence of DAO in the sample is correlated to a colorimetric reaction resulting from the change of color of a dye reacting with H₂O₂.

According to this particular embodiment, a substrate such as histamine, putrescine, cadaverine and/or combinations thereof is fixed/cross-linked to the working electrode. The substrate is mixed with a polymer (such as chitosan, collagen and fluoren (a semiconductor) in order to improve conductivity. The substrate may be mixed chitosan and collagen to preserve the enzyme and prevent its degradation during the reaction. Examples of suitable substrate materials include for instance putrescine dihydrochloride (NH₂(CH₂)₄NH₂.2HCl, P7505, Sigma-Aldrich), histamine dihydrochloride (C₅H₉N₃.2HCl, 776084, Sigma-Aldrich) and cadaverine dihydrochloride (NH₂(CH₂)₅NH₂.2HCl, 33220, Sigma-Aldrich).

The mixture may also comprise a surfactant such as sodium dodecylbenzenesulfonate (SDBS) (e.g. about 0.3-0.5) [symbol] to prevent agglutination of fluoren and to reduce static electricity from working electrode.

In one particular embodiment, the substrate was prepared using putrescine dihydrochloride was obtained from Sigma-Aldrich to prepare a 5.32 mg/mL de solution in a buffer phosphate (PBS, 100 mM, pH 7.4). The substrate was next immobilized on two membranes (chitosan and collagen) at surface of the working electrode. The substrate was immobilized on a membrane of chitosan-collagen allowing covalent immobilization of substrate. Briefly, 3 mL of a PBS solution containing 240 mM of putrescine, was deposited on 1 cm² of chitosan-collagen membrane. The affinity membrane with the substrate was left to dry for 1 hour.

To manufacture an elongated strip for the detection of DAO, the affinity membrane and the substrate were placed on the working electrode in the following order: (1) the membrane of cellulose acetate or other organic polymer to protect the electrode electrochemical interference; (2) the Substrate (e.g. histamine, cadaverine or putrescine) and (3) outer polycarbonate or chitosan-collagen to protect the Substrate from harmful molecules and/or from bacteria.

For detection of DAO, the mixture of compounds 55 may be assembled in multiple layers in the same manner as described hereinbefore for detection of histamine, and as illustrated in FIG. 5.

Headings are included herein for reference and to aid in locating certain sections. These headings are not intended to limit the scope of the concepts described therein, and these concepts may have applicability in other sections throughout the entire specification. Thus, the present invention is not intended to be limited to the embodiments shown herein but is to be accorded the widest scope consistent with the principles and novel features disclosed herein.

The singular forms “a”, “an” and “the” include corresponding plural references unless the context clearly dictates otherwise. Thus, for example, reference to “a compound” includes one or more of such compounds, and reference to “the method” includes reference to equivalent steps and methods known to those of ordinary skill in the art that could be modified or substituted for the methods described herein.

Unless otherwise indicated, all numbers expressing quantities of ingredients, reaction conditions, concentrations, properties, and so forth used in the specification and claims are to be understood as being modified in all instances by the term “about”. At the very least, each numerical parameter should at least be construed in light of the number of reported significant digits and by applying ordinary rounding techniques. Accordingly, unless indicated to the contrary, the numerical parameters set forth in the present specification and attached claims are approximations that may vary depending upon the properties sought to be obtained. Notwithstanding that the numerical ranges and parameters setting forth the broad scope of the embodiments are approximations, the numerical values set forth in the specific examples are reported as precisely as possible. Any numerical value, however, inherently contains certain errors resulting from variations in experiments, testing measurements, statistical analyses and such.

It is understood that the examples and embodiments described herein are for illustrative purposes only and that various modifications or changes in light thereof will be suggested to persons skilled in the art and are to be included within the present invention and scope of the appended claims.

What is claimed is:

1.-33. (canceled)

34. A device for the detection of at least one analyte in a liquid sample, comprising:
a separation zone for depositing a liquid sample comprising at least one analyte to be detected and other constituents, wherein said at least one analyte has a greater size and a charge different from other constituents in the liquid sample;
a reaction zone for receiving and reacting said at least one analyte;
a neutral zone in between the separation zone and the reaction zone, the neutral zone allowing flow said at least one analyte from the separation zone to the reaction zone;
wherein said at least one analyte is detected at the reaction zone by at least one of amperometry, potentiometry, colorimetry and photometry.

35. The device of claim 34, wherein said membrane comprises pores having a size allowing passage of said at least one analyte but not passage of constituents in the liquid sample.

36. The device of claim 34, wherein said separation zone comprises: (i) a first electrode extending above said membrane and positioned to be in fluid communication with an upper surface of the microporous membrane; and (ii) a second electrode extending below said membrane and positioned to be in fluid communication with a lower surface of the microporous membrane; each of said electrode comprising a connector adapted to be connected to an electrical source.

37. The device of claim 34, wherein the first electrode is adapted to induces an electric current having a first charge attracting said at least one analyte while repulsing constituents having a size smaller than the size of the pores, and wherein the second electrode is adapted to induces an electric current having an opposite charge attracting said constituents having a size smaller than the size of the pores while repulsing said at least one analyte.

38. The device of claim 34, wherein the separation zone and the neutral zone provide for a flow of said at least one analyte by at least one of capillary action and gravity.

39. The device of claim 34, wherein the reaction zone comprises a mixture of compounds allowing an electrochemical reaction with said at least one analyte reaching the reaction zone, and wherein said electrochemical reaction generates a measurable current.

40. The device of claim 34, wherein potential of the current is proportional to an amount of said at least one analyte reaching the reaction zone.

41. The device of claim 34, wherein said device further comprises measuring an electric current at the reaction zone, and wherein potential of said electric current is proportional to an amount said at least one analyte reaching the reaction zone, thereby allowing quantification of said at least one analyte.

42. The device of claim 34, wherein said measurable current is measured by using an amperometric detector and/or an potentiometric detector.

43.-65. (canceled)

66. The device of claim 34, wherein said analyte is selected from the group consisting of synthesized molecules, cells, nucleic acids, proteins, and lipids.

67. The device of claim 34, wherein said liquid sample is a biological sample selected from the group consisting of blood, plasma, saliva, urine, amniotic liquid, and vaginal secretions.

68. The device of claim 34, wherein said membrane is a polycarbonate membrane.

69. The device of claim 34, wherein said at least one analyte is histamine or diamine.
